(19) United States
(12) Patent Application Publication
(10) Pub. No.: US 2013/0110395 A1
(43) Pub. Date: May 2, 2013

(54) Method for Accurately Determining the Locations of Public Transportation Stations

(71) Applicant: Tomer Yosef Morad, Tel Aviv (IL)

(72) Inventor: Tomer Yosef Morad, Tel Aviv (IL)

(21) Appl. No.: 13/514,370

(22) PCT Filed: Dec. 14, 2010
(86) PCT No.: PCT/IL2010/001056

§ 371 Date: Oct. 22, 2012

(30) Foreign Application Priority Data
Dec. 15, 2009 (IL) 202733

(51) Int. Cl. G01C 21/32

(52) U.S. Cl. CPC G01C 21/32
USPC 701/468

(57) ABSTRACT

The present invention relates to a method for approximating the location of a public transportation station comprising the steps of: (a) receiving the coordinates of a station of said public transportation; (b) receiving a number of GPS readings, each indicative of the location of said station of said public transportation; (c) filtering said GPS readings in relation to said coordinates of the said station of said public transportation; and (d) calculating said approximated location of the public transportation station based on said filtered GPS readings.

### FIELD OF THE INVENTION

The present invention relates to the field of finding the locations of public transportation stations. More particularly, the invention relates to a method for accurately determining the locations of stations on a public transportation route based on GPS readings.

### BACKGROUND OF THE INVENTION

Manually actuated systems for announcing the stations on public transportation vehicles are known. Such systems store digital information corresponding to each preset station, on a known route, either as a digitized voice or as a text for display. As a vehicle approaches a station, the driver can actuate the system by pressing a button effectually causing the digital voice or textual display to announce the station. Each time the driver actuates the system a station is announced, and the list of the stations is progressed in order to allow the correct announcements of the subsequent stations. Of course, if a driver neglects to actuate the system at a station, the subsequent stations are erroneously announced. Therefore, it is desired to automate the actuating of the announcing system in order to overcome the problems of the manually actuated error prone system.

One of the known methods for automatically actuating the announcing system includes a list of stations coordinates and a GPS receiver, which provides periodic latitude and longitude coordinate readings. The automated announcing system, which is coupled to the GPS receiver, can track the traveling coordinates periodically during traveling in route. The tracked coordinates are compared to the predetermined list of coordinates of the stations, and when the vehicle is near a station, the information related to that station is announced, such as described in U.S. Pat. No. 5,808,565. Nevertheless, determining the accurate coordinates of the predetermined stations for listing is not trivial.

As of today a number of methods exist for determining the locations of public transportation stations. One option is to send an operator, with a GPS receiver, traveling on the public transportation route to record the location of the stations manually at each station. Nevertheless, this method is error prone as it is based entirely on a manual operator, and is exposed to human errors and inaccuracies. Furthermore, this method requires much investment, as an operator needs to be dispatched each time there is a reason to believe that one of the stations has been relocated.

It is an object of the present invention to provide a method for determining the locations of public transportation stations automatically and accurately.

It is another object of the present invention to provide a method for locating a station, during travel on a public transportation route, and announcing information linked with that station.

It is still another object of the present invention to provide a method for automatically updating the location of relocated stations on a public transportation route.

Other objects and advantages of the invention will become apparent as the description proceeds.

### SUMMARY OF THE INVENTION

The present invention relates to a method for approximating the location of a public transportation station comprising the steps of: (a) receiving the coordinates of a station of said public transportation; (b) receiving a number of GPS readings, each indicative of the location of said station of said public transportation; (c) filtering said GPS readings in relation to said coordinates of the said station of said public transportation; and (d) calculating said approximated location of the public transportation station based on said filtered GPS readings.

Preferably, the calculating of the approximated location of the public transportation station is done by selecting the GPS readings that are within a proximity to the coordinates of the received station of said public transportation and calculating the average location of said selected GPS readings.

In one embodiment, the calculating of the approximated location of the public transportation station is done by selecting the GPS readings that are within a proximity to the coordinates of the received station of said public transportation and calculating the median of said selected GPS readings.

In another embodiment, the calculating of the approximated location of the public transportation station is done by ranking the GPS readings based on the number of said GPS readings in the stop accuracy range of each of said GPS readings and selecting the GPS reading with the highest rank as the location of the public transportation station.

In one embodiment the calculating of the approximated location of the public transportation station is done by: (a) ranking the GPS readings, where said ranking is done by counting the number of GPS readings in the stop accuracy range of each of said GPS readings; (b) filtering said GPS readings based on their said rank, where said filtering is done by removing all said GPS readings that have a higher ranking GPS reading within their cluster accuracy range; (c) calculating a metric on the remaining readings, where said metric is calculated using neural networks for pattern recognition that are trained with patterns indicative of stations and their corresponding verified station coordinates; and (d) selecting the GPS reading with the highest metric as said approximated location of the public transportation station.

In one embodiment, the method is used for updating the public transportation stops locations.

Preferably, the traffic stops are filtered from the GPS readings indicative of the location of the station.

In one embodiment, the filtering is done by removing GPS stop readings with stop durations of above a certain time threshold.

In one embodiment, the filtering is done using indication from the door of the public transportation vehicle.

In one embodiment, the filtering is done using indication from the public transportation vehicle's ticketing system.

In one embodiment, the filtering is done using indication from the public transportation vehicle's passenger counting system.

In one embodiment, the filtering is done by interpolating the indications from the public transportation vehicle with the GPS readings.

### BRIEF DESCRIPTION OF THE DRAWINGS

In the drawings:

FIG. 1 is an example of a schematic picture depicting a map of coordinate locations, resembled by thumbnails, on a segment of a route.

FIG. 2 is a block diagram of the process for finding the accurate location of stations on a public transportation route, according to one embodiment.

FIG. 3 is a top view picture depicting a map of GPS readings, resembled by thumbnails, of a public transportation vehicle traveling on a road segment, according to one embodiment.

### DETAILED DESCRIPTION OF PREFERRED EMBODIMENTS

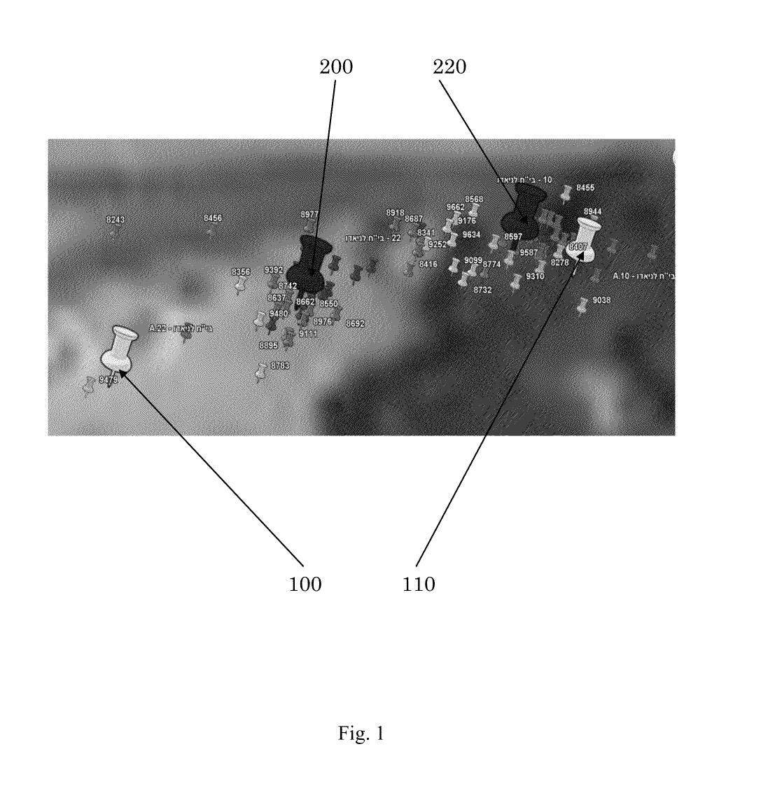

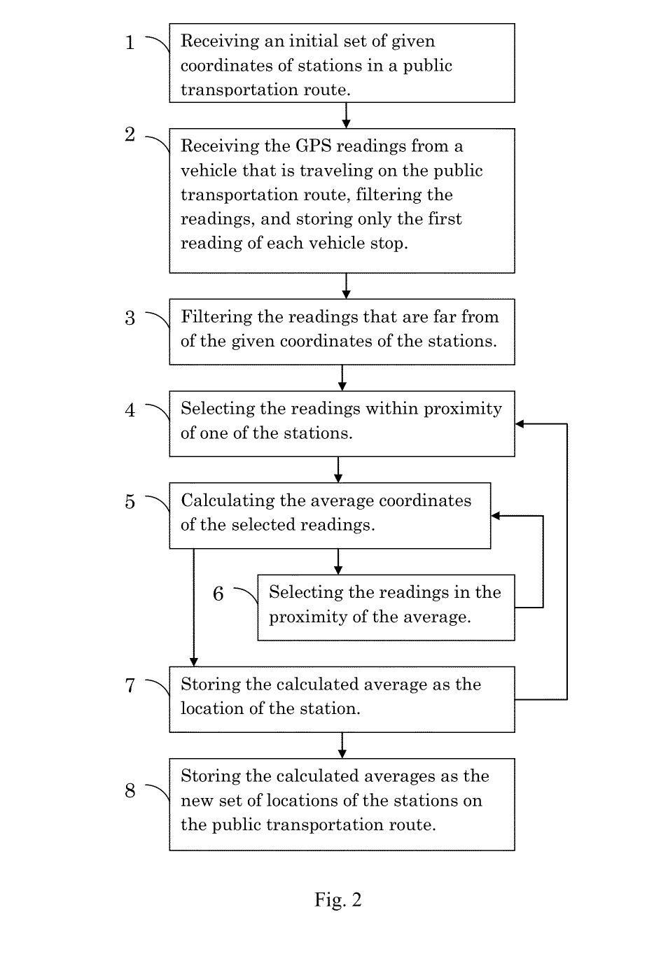

FIG. 1 is an example of a schematic picture depicting a map of coordinate locations, resembled by thumbnails, on a segment of a route, according to one embodiment. At first, a number of initial coordinates are given; where each given set of coordinates suggest the location of a station. The terms coordinate or coordinates include hereinafter: longitude and latitude coordinates, Cartesian coordinates, cylindrical coordinates, polar coordinates, GPS readings, or any other localizing data that indicates a location. The terms station or stations refer hereinafter to stopping locations set for loading and/or unloading passengers and/or cargo. The given initial station coordinates may have been determined manually, or using any other method. Nevertheless, these given initial station coordinates, which are resembled by the big white thumbnails 100 and 110, may locate the stations inaccurately. The big black thumbnails 200 and 220 resemble the more accurate locations of the stations as interpolated by the method described below in relation to FIG. 2. The small colored thumbnails resemble the coordinates of the stop locations derived from the GPS readings of vehicles traveling the depicted road segment, according to an embodiment. In this picture the depicted GPS readings are taken from many travels made on the depicted road segment of a transportation route. The deviations in the readings may be caused by the different physical locations in which the vehicles stopped accumulated with the measurement errors exhibited by the GPS device. In one embodiment at least 10 travels are made on the same road segment of the transportation route.

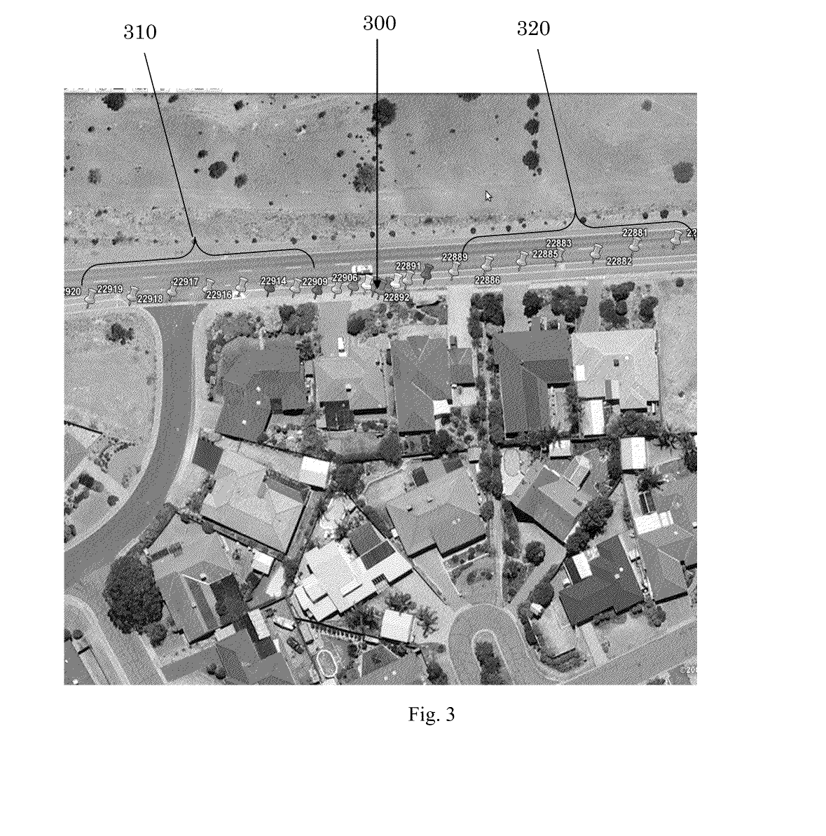

FIG. 2 is a block diagram of the process for finding the accurate location of stations on a public transportation route, according to one embodiment. The term public transportation may include hereinafter a bus, a train, a boat, a garbage truck, or any other vehicle used for public transportation. At step 1, a given set of initial coordinates of the stations on the public transportation route are received, such as depicted in FIG. 1 resembled by thumbnails 100 and 110. In step 2, the GPS readings of stops from vehicles traveling on the public transportation route are received, such as depicted by the small thumbnails in FIG. 1, where the readings are filtered in order to save only the first reading of each vehicle stop. The process of determining the stops coordinates is described in relations to FIG. 3. In this embodiment, the GPS readings of stops belong to a number of travels made on the same route, such as depicted in FIG. 1. The required number of stops may vary according to the needs of the system, such as a minimum of one reading; nevertheless, typically, more readings yield a more accurate result and allow accounting for the measurement errors of the GPS devices and the different physical locations in which the vehicles stopped. In step 3, the GPS readings are filtered by deleting all the GPS readings which are too far from the given initial station coordinates, e.g. a radius of 80 meters. For example, any reading which does not point to a location in the proximity of 80 meters of any one of the given initial coordinates is filtered. In step 4, one of the given initial coordinates is chosen and the GPS readings pointing to locations within the proximity of that chosen coordinate are selected. The proximity may vary, according to the needs of the system, e.g. proximity of 5 meters radius. In step 5 the selected readings, i.e. the readings pointing to a location within the proximity, are processed together for calculating their average location. For example, all the readings which are in the radius of 5 meters from the given coordinate resembled by thumbnail 110 are processed together and their average location is calculated. By average location it is meant to include the average longitude coordinate of the processed readings in the proximity and the average latitude coordinate of the processed readings in the proximity, or any other known averaging method. In one of the embodiments the median of the readings in the proximity is found instead of calculating the average. In step 6, the GPS readings pointing to a location within the proximity of the calculated average location are selected. This proximity may also vary according to the needs of the system, e.g. a radius of 5 meters. Steps 5 and 6 may be repeated in cycle for a number of times, where each cycle may refine the estimated average location. In one embodiment the steps 5 and 6 are repeated for 5 cycles. In another embodiment steps 5 and 6 are repeated until the calculated average is relatively close to the previous cycle calculated average, such as within a meter of the calculated average of the previous cycle. Once the average is calculated and refined, in step 5, after the described processing cycles, its coordinates are saved in step 7 as the estimated location of the station. As shown in FIG. 1, the black thumbnail 220, which points at the estimated location of the station as processed, points at the location of the station more accurately than the white thumbnail 110 which points at the given initial coordinates of the station. Steps 4-7 are repeated for each of the given initial coordinates of stations. In step 8 the calculated locations of the stations are stored as the locations of the stations of the public transportation route. In one embodiment, the described method is used for replacing the given initial coordinates of stations with the more accurate set of calculated stations coordinates.

In one of the embodiments, the method described in relation to FIG. 2 is used for updating the locations of stations on a public transportation route. For example, when a road is redesigned the public transportation stations may be relocated. Thus the described method may be used for updating the new location of the relocated stations, or for detecting that the road has been redesigned. In this embodiment, the initial given coordinates are actually the original coordinates of the stations before they were relocated. In one of the embodiments, the method described in relations to FIG. 2 is applied periodically in public transportation vehicles, in order to update the system of any relocated stations. In one of the embodiments, a station coordinates are updated only when it is found that the station has moved by more than a certain threshold, such as 10 meters.

FIG. 3 is a top view picture depicting a map of GPS readings, resembled by thumbnails, of a public transportation vehicle traveling on a road segment, according to one embodiment. In this embodiment the GPS readings are received every second and the speed of the vehicle can be calculated at each part based on the locations from the GPS readings. As shown in the picture, the left side GPS readings locations 310 and the right hand GPS readings locations 320 are well spaced which indicates travel at a certain speed. For example, a space of 5 m between the locations from two subsequent GPS readings indicates that the vehicle is traveling at a speed of 18 Km/h. However, in the proximity of the location 300 the GPS readings locations are denser indicating a drop in speed or a total stop of the vehicle. For example, a space of less than 83 cm between locations of two subsequent GPS readings indicates a vehicle speed of less than 3 Km/h. Although GPS readings may have a bias in their location, the GPS bias is not arbitrary as known in the art. The GPS bias acts similar to a drift, meaning that subsequent GPS readings have a correlated bias. Therefore, since the bias of subsequent readings is correlated, the calculation of the speed of the vehicle may be found with a higher accuracy than its location. In one embodiment a stop is recognized when the calculated velocity of the vehicle is lower than 3 Km/h, and its distance from the last stop is larger than 5 m.

In one of the embodiments the GPS readings pointing at public transportation stations are separated from the GPS readings pointing at traffic stops, where only the GPS readings pointing to the public transportation stations are processed by the method described in relations to FIG. 2. The term traffic stops includes stops made for traffic light stops, traffic jams, stop signs, or any other stops that are not otherwise related to loading and unloading passengers. In one embodiment, the traffic stops are separated from the public transportation stations using a time threshold, e.g. 30 seconds, where a stop of less than the threshold indicates a station and a stop of more than the threshold indicates a traffic stop. In another embodiment the traffic stops are separated from the public transportation stations by location variance, taken over a number of travels on the same route. For example, if in a certain vicinity the variance of the locations of the stops, as pointed by the GPS readings, is greater than a certain threshold, then these GPS readings are viewed as belonging to traffic stops. In one embodiment the variance is calculated by the average of the square of the distances from the GPS readings to the average location of the GPS readings. In one of the embodiments, the traffic stops are separated from the public transportation stations by time variance, taken over a number of travels on the same route. A stop time variance over a certain threshold may determine that the reading indicating a stop may be viewed as belonging to a traffic stop. In one of the embodiments, the GPS readings taken on a public transportation vehicle, required to stop at certain stations on the route, are compared with GPS readings taken on another vehicle traveling the same road which is not required to stop at these stations. Thus the GPS readings of stops of the public transportation vehicle may be filtered with the GPS readings of stops of the other vehicle. For example, if both vehicles stopped at the same location, this location may suggest a stop for a traffic light. In one of the embodiments all the GPS readings of a public transportation vehicle are processed for finding a deviation from the road. For example, if the GPS readings show that the vehicle has departed from the straight course of traveling and stopped, that stop may be viewed as a station.

In some of the embodiments the determining of the GPS readings pointing at a public transportation station are found by interpolating indications from other systems of the public transportation vehicle together with the GPS readings. In one embodiment, indications from the vehicle's door are used to find the GPS readings that are pointing at the locations of the public transportation stations. In one embodiment, indications from the vehicle's ticketing system are used to find the GPS readings that are pointing at the locations of the public transportation stations. In one embodiment, indications from the vehicle's passenger counting system are used to find the GPS readings that are pointing at the locations of the public transportation stations. In one embodiment an interpolation of all or some of the above mentioned indications is made, where some of the indications may be more significant than others. In one of the embodiments a human operator compares the GPS readings of stops on the route with a map of the route and cancels the stops belonging to traffic stops. In yet another embodiment a list of traffic stops and their respective accurate locations are used to filter the stops belonging to traffic stops.

In one embodiment the process for finding the accurate location of a station on a public transportation route is practiced by first receiving the GPS readings and then filtering the readings that are far from the given station coordinates. After this initial filtering the readings that are not considered as a vehicle stop are also filtered. The second filtering may be done by: (a) filter readings that indicate a speed of 3 kph and above, (b) keeping only the first reading after the vehicle speed is below 3 kph, (c) resuming the search for a new stop only after the subsequent readings show that the speed has risen above 3 kph, and (d) filter the readings related to traffic stops. Then the stop accuracy range is selected. In one embodiment the stop accuracy range is selected to be twice the standard deviation of error of the specific GPS device used. In another embodiment the stop accuracy range is selected to be the physical size of the stopping area of the vehicle. At this point each reading is processed for calculating its rank, which equals to the number of readings in its surrounding stop accuracy range. In one embodiment, when calculating the rank of a reading, only readings within its stop accuracy range that have been acquired from different vehicle journeys are considered, so that the rank will reflect the number of different journeys in which the vehicles stopped at its stop accuracy range. Then, the cluster accuracy range is selected. In one embodiment the cluster accuracy range is selected to be the physical size of the stopping area. After that, the readings are processed iteratively in the following manner: (a) The highest ranking reading that has not been marked yet is selected and marked, and (b) the readings that are within the cluster accuracy range of the selected reading are eliminated. This process continues until all readings have either been marked or eliminated. In one of the embodiments the highest ranking marked reading is suggested as the station position. In another embodiment, the marked readings are then processed to find the most likely station position using various metrics. In one embodiment the metric is the ranking itself. In another embodiment the metric used for each reading is its ranking divided by its distance from the initial coordinates of the station, where the highest result of the division is suggested as the station position. In yet another embodiment the marked readings are ranked again using pattern recognition techniques to distinguish readings of stations from readings of traffic stops. Such pattern recognition techniques may involve machine learning neural network techniques, that are trained with stop readings and verified location coordinates. Thus the reading with the highest metric is suggested as the station position. In one of the embodiments a human intervention is required where the readings with their ranking and calculated metrics are supplied to a user interface for a user's decision.

In one of the embodiments the stop accuracy range is iteratively increased and each reading is rated according to the number of readings located within its stop accuracy range. This process may be continued until the stop accuracy range is increased enough so that one of the readings includes a certain number of other readings located within its stop accuracy range, e.g. 70% of the readings located within the accuracy range. Once a reading and its increased stop accuracy range engulfs the preset number of readings, that reading is suggested as the station position.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the invention or exceeding the scope of claims.

1. A method for approximating the location of a public transportation station comprising the steps of
a. receiving the coordinates of a station of said public transportation;
b. receiving a number of GPS readings, each indicative of the location of said station of said public transportation;
c. filtering said GPS readings in relation to said coordinates of the said station of said public transportation; and
d. calculating said approximated location of the public transportation station based on said filtered GPS readings.

2. A method according to claim 1, where the calculating of the approximated location of the public transportation station is done by selecting the GPS readings that are within a proximity to the coordinates of the received station of said public transportation and calculating the average location of said selected GPS readings.

3. A method according to claim 1, where the calculating of the approximated location of the public transportation station is done by selecting the GPS readings that are within a proximity to the coordinates of the received station of said public transportation and calculating the median of said selected GPS readings.

4. A method according to claim 1, where the calculating of the approximated location of the public transportation station is done by ranking the GPS readings based on the number of said GPS readings in the stop accuracy range of each of said GPS readings and selecting the GPS reading with the highest rank as the location of the public transportation station.

5. A method according to claim 1, where the calculating of the approximated location of the public transportation station is done by:
a. ranking the GPS readings, where said ranking is done by counting the number of GPS readings in the stop accuracy range of each of said GPS readings;
b. filtering said GPS readings based on their said rank, where said filtering is done by removing all said GPS readings that have a higher ranking GPS reading within their cluster accuracy range;
c. calculating a metric on the remaining readings, where said metric is calculated using neural networks for pattern recognition that are trained with patterns indicative of stations and their corresponding verified station coordinates; and
d. selecting the GPS reading with the highest metric as said approximated location of the public transportation station.

6. A method according to claim 1, where the method is used for updating the public transportation stops locations.

7. A method according to claim 1, where traffic stops are filtered from the GPS readings indicative of the location of the station.

8. A method according to claim 7, where the filtering is done by removing GPS stops readings with stop durations of above a certain time threshold.

9. A method according to claim 7, where the filtering is done using indication from the door of the public transportation vehicle.

10. A method according to claim 7, where the filtering is done using indication from the public transportation vehicle's ticketing system.

11. A method according to claim 7, where the filtering is done using indication from the public transportation vehicle's passenger counting system.

12. A method according to claims 9-11, where the filtering is done by interpolating the indications from the public transportation vehicle with the GPS readings.
